(19) United States
(12) Patent Application Publication
(10) Pub. No.: US 2015/0013863 A1
(43) Pub. Date: Jan. 15, 2015

(54) Tire With Pre-Formed Tread And Method Of Making Same

(71) Applicant: Bridgestone Americas Tire Operations, LLC, Nashville, TN (US)

(72) Inventors: Dennis W. Snyder, Uniontown, OH (US); Samuel Givens, Copley, OH (US); Jacob Walters, Medina, OH (US); Adam K. Nesbitt, Akron, OH (US); Jon I. Stuckey, Louisville, OH (US)

(21) Appl. No.: 14/182,404

(22) Filed: Feb. 18, 2014

Related U.S. Application Data
(60) Provisional application No. 61/846,591, filed on Jul. 15, 2013.

(51) Int. Cl. B60C 11/03; B29D 30/66; B60C 11/00

(52) U.S. Cl. CPC B60C 11/0311; B60C 11/00; B29D 30/66; B60C 2200/08; B29K 2105/246
USPC 152/209.12; 156/128.1; 156/123

(57) ABSTRACT

Methods of making tires with features such as ribs, lugs, or tread blocks include shaping at least one feature onto an uncured tire tread prior to vulcanization. One aspect of these methods may include shaping a feature onto the tread while the tread is associated with the tire. Shaping devices may include shaping rollers, stitching rollers, pre-molds, and annular, curved, or flat stamping plates. An additional aspect of these methods may further reduce the amount of air between a tread and carcass prior to vulcanization. These methods may be used in conjunction with manufacturing processes used on various types of tires, and are particularly suitable for use in large tire manufacturing processes.

### CROSS-REFERENCE TO RELATED APPLICATIONS

This application claims priority from U.S. Provisional Patent Application No. 61/846,591, filed on Jul. 15, 2013, the disclosure of which is incorporated by reference herein in its entirety.

### FIELD OF INVENTION

This disclosure relates to the field of tire constructions and methods of tire construction. More particularly, the disclosure relates to tires with features such as ribs, lugs, or tread blocks and methods of making tires with these features. Further, the disclosure also describes agricultural tires and methods of making agricultural tires.

### BACKGROUND

Known tire manufacturing methods involve building a green tire, including a green tread, and vulcanizing the green tire and tread in a mold. When a green tire is placed in a mold, the volume between the green tire and the mold features must be filled with rubber. Thus, viscous rubber flows into the volume between the green tire and the mold features. The viscous rubber and green tire are cured during vulcanization.

### SUMMARY OF THE INVENTION

In one embodiment, a method of manufacturing a tire comprises the steps of providing a sheet of green tire tread compound, shaping at least one integral lug on the sheet of green tire tread compound with at least one roller, placing the sheet of green tire tread compound on a green carcass, placing the green tire tread compound and green carcass into an tire mold, curing the green tire tread and green carcass, and removing the cured tire from the mold. As one of ordinary skill in the art will understand, this method is suitable for manufacturing various types of tires, and is particularly suitable for manufacturing large tires. Additionally, one of ordinary skill in the art will understand that the sequential ordering of the steps in this embodiment may be varied.

In another embodiment, a method of manufacturing a tire comprises the steps of providing an uncured tire, the uncured tire comprising at least a carcass and a tread, introducing the uncured tire to a tread or void negative, applying pressure to the tread or void negative to at least partially impart a circumferential profile upon the uncured tire, and vulcanizing the uncured tire in order to obtain a vulcanized tire. As one of ordinary skill in the art will understand, this method is suitable for manufacturing various types of tires, and is particularly suitable for manufacturing large tires. Additionally, one of ordinary skill in the art will understand that the sequential ordering of the steps in this embodiment may be varied.

In yet another embodiment, a green tire includes a carcass and a pre-shaped tread, wherein the carcass includes a pair of annular beads configured to secure the tire to a wheel, at least one body ply extending between the annular beads, a circumferential belt, the circumferential belt configured to provide structural reinforcement to the tire, and, the pre-shaped tread is an integral rubber article comprising a tread base layer having a base gauge and skid lugs, wherein the skid lugs are deep skid lugs configured for use on a tire. As one of ordinary skill in the art will understand, this construction is suitable for various types of tires, and is particularly suitable for large tires, including agricultural tires.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1A is a partial perspective view of an embodiment of a green tread;

FIG. 1B is a partial perspective view of an embodiment of a green tread for use in large tires;

FIG. 1C is a partial perspective view of an embodiment of a green tread for use in large tires having a reduced tread gauge;

FIG. 1D is a partial perspective view of an embodiment of a green tread for use in tires having ribs;

FIG. 2A is a perspective view of a shaping roller;

FIG. 2B is a side view of a shaping roller assembly and a green tread;

FIG. 3A is a cross-sectional view of a green tire;

FIG. 3b is a perspective view of a green tire and green tread;

FIG. 4 is a side view of a stitching roller and a green tire having an uncured carcass and an uncured tread; and

FIG. 5 is a perspective view of a blank mold having mold features.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Equatorial plane” refers to the plane that is perpendicular to the tire's axis of rotation and passes through the center of the tire's tread.

“Radial” and “radially” refer to a direction perpendicular to the axis of rotation of a tire.

“Sidewall” as used herein, refers to that portion of the tire between the tread and the bead.

“Tread” as used herein, refers to that portion of the tire that comes into contact with the road or ground under normal inflation and load.

While similar terms used in the following descriptions describe common tire components, it is understood that because the terms carry slightly different connotations, one of ordinary skill in the art would not consider any one of the following terms to be purely interchangeable with another term used to describe a common tire component.

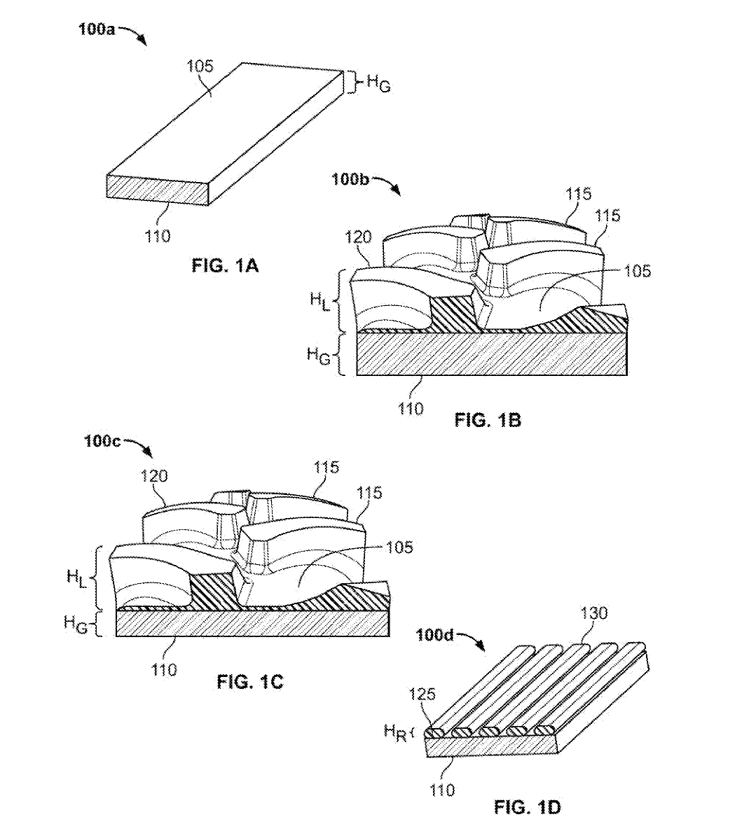

FIGS. 1A-1D show a variety of green tire treads. As one of ordinary skill in the art would understand, a green tread is a rubber member that has yet to be vulcanized. FIG. 1A shows a green tread 100a that is substantially flat. Green tread 100a has a top surface 105 and a bottom surface 110. Top surface 105 and bottom surface 110 are separated by a tread gauge height, H_{G}. Green tread 100a can be used in a variety of different tire applications.

As one of ordinary skill in the art will understand, green tread 100a is placed on a tire carcass to form a green tire. The green tire is then placed in a vulcanization mold. During curing of the green tire, rubber flows into voids of the vulcanization mold.

FIG. 1B shows a green tread 100b with preformed lugs (or bars) 115. Like tread 100a, tread 100b has a top surface 105 and a bottom surface 110. In tread 100b, lugs 115 rise from top surface 105 to outer edge 120. As shown, lugs 115 begin at the tread's outer edges and arc toward the center of the tread. Further, as shown, the lugs 115 have a height, H_{L}, which represents the distance between top surface 105 and outer edge 120. The lugs may be defined by a bar angle (not shown) that represents the average inclination of the lugs with respect to the tread's equatorial plane. As one of ordinary skill in the art would understand, the lugs 115 may vary in shape, height, and inclination, and do not necessarily begin or end at any specific location on the green tread.

As shown, tread 100b and lugs 115 are an integral article of manufacture. In another embodiment (not shown), tread 100b and lugs 115 begin as distinct articles, and lugs 115 are then either placed on or affixed to tread 100b during the manufacturing process. In this alternative embodiment, the lugs may be chemically or mechanically affixed to the tread.

FIG. 1C shows a green tire tread 100c with lugs 115. Tread 100c contains many of the same features as tread 100b. In comparison to tread 100b, tread 100c has a reduced tread gauge height, H_{G}, but it has an identical tread lug height, H_{L}. Thus, the ratio H_{G}/H_{L} is lower in tread 100c than in tread 100b. In alternative embodiments, lug height H_{L} is varied. As one of ordinary skill in the art would understand, a lower H_{G}/H_{L} ratio is desirable in certain tire applications. Likewise, a lower H_{G}/H_{L} ratio will reduce the amount of rubber needed in a given build.

FIG. 1D shows a green tire tread 100d with ribs 125. Like treads 100a-100c, tread 100d has a top surface 105 and a bottom surface 110. In tread 100d, ribs 125 rise from top surface 105 to outer edge 120. As shown, the ribs 125 are divided by circumferential grooves 130. The ribs 125 occupy a portion of the tread's width and will run circumferentially around a finished tire. Further, as shown, ribs 125 have a height, H_{R}, which represents the distance between top surface 105 and outer edge 120. As one of ordinary skill in the art would understand, the ribs 125 may vary in shape and height, and do not necessarily have to begin or end at any specific location on the tread. In alternative embodiments, the continuity of the ribs is interrupted by various features, including, but not limited to, various grooves, slots, and sipes.

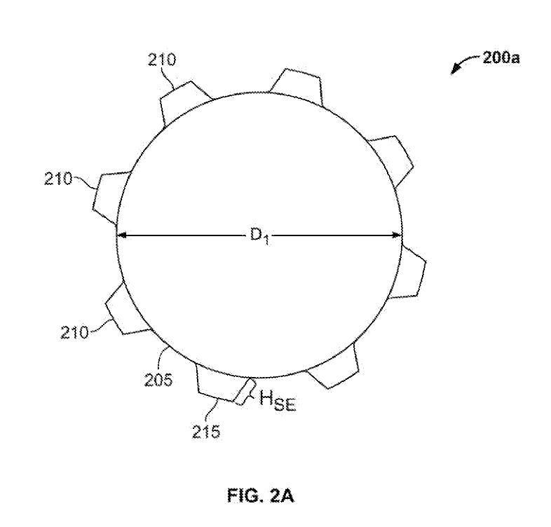

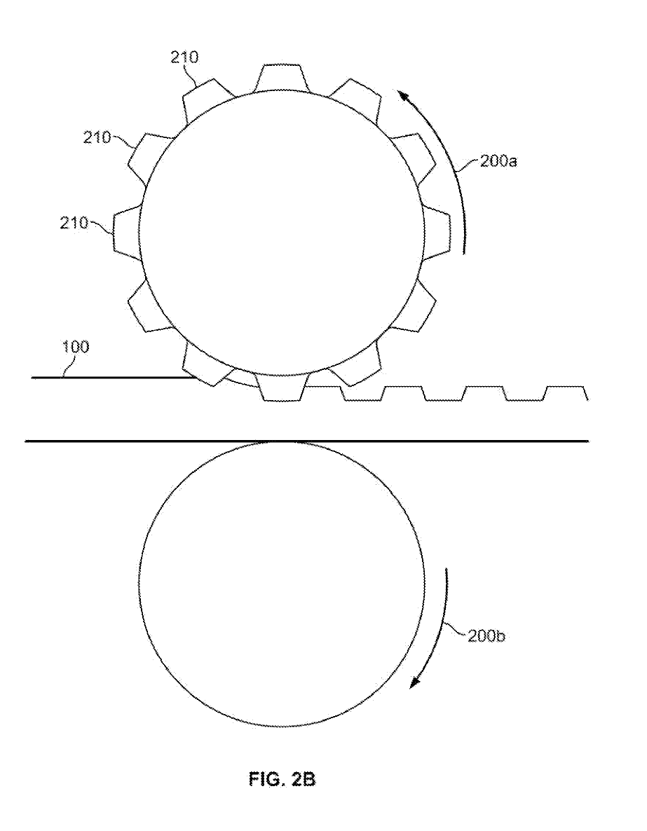

FIG. 2A shows a shaping roller 200a. As shown, shaping roller 200a is generally cylindrical and has a diameter, D. The diameter extends between opposite edges of the shaping roller's top surface 205. Although diameter D is shown as one size, one of ordinary skill would understand that the length of diameter D may be varied on an application-by-application basis.

As shown, shaping roller 200a includes shaping elements 210 that extend from top surface 205. As shown, the shaping elements 210 have a height, H_{SE}, which represents the distance between top surface 205 and outer edge 215. In one embodiment, the inclination of the shaping elements 210 generally corresponds to the inclination of the voids, grooves and sipes in a finished tread. As one of ordinary skill in the art would understand, increasing the similarity between the shaping elements and the mold features will help to reduce rubber flow in the curing press. However, the shaping elements may depart from the geometry of a finished tread.

In this embodiment, the shaping elements are a tread pattern. In an alternative embodiment, shaping elements 210 generally correspond to a tread negative. In this embodiment, the shaping elements generally correspond to a tread negative by occupying at least 40% of a finished tire's void, groove, and sipe volume. In another embodiment, shaping elements 210 generally correspond to the larger voids in a tread. In this embodiment, the shaping elements generally correspond to the larger voids in a tread by occupying at least 30% of the finished tire's void volume. In another embodiment, the shaping elements closely correspond to the larger voids in a tread by occupying at least 80% of the finished tire's void volume.

In one embodiment, the height of the shaping elements, H_{SE}, varies between 50% and 100% of H_{L} or H_{R}. In one particular embodiment, the height of the shaping elements, H_{SE}, varies between 60% and 80% of H_{L} or H_{R}.

In an alternative embodiment (not shown), a stamping plate is used instead of a shaping roller. The stamping plate may be annular, curved, or flat.

FIG. 2B shows shaping roller 200a, shaping roller 200b, and a green tread 100. In FIG. 2B, shaping roller 200a is the same shaping roller shown in FIG. 2A. As shown, shaping roller 200b is generally cylindrical and has a top surface 205. While shaping roller 200b is similar to shaping roller 200a, shaping roller 200b, as shown, lacks shaping elements. Additionally, as one of ordinary skill in the art would understand, shaping roller 200a and shaping roller 200b may have different diameters.

As depicted in FIG. 2B, shaping roller 200a spins counterclockwise and shaping roller 200b spins clockwise as green tread 100 is fed from left to right. As one of ordinary skill in the art would understand, providing a sheet of tread compound may involve extruding rubber. In an alternative embodiment, extruding rubber may provide a reduced-gauge sheet of green agricultural tire tread compound.

When tread 100 contacts the shaping rollers, the shaping rollers begin the process of imparting a tread profile upon the tread. As one of ordinary skill in the art will understand, beginning the process of imparting a tread profile upon the tread involves imparting at least a portion of one of the features that will appear in a finished tire. For example, in a tire for large vehicles, imparting a profile upon the tread could involve pre-shaping a portion of at least one skid lug. Thus, in one embodiment, the shaping rollers begin the process of imparting a large-vehicle tread profile upon the tread. In another embodiment, the shaping rollers begin the process of imparting an agricultural tread profile upon the tread. In yet another embodiment, the shaping rollers begin the process of imparting a truck or bus tread profile upon the tread. In a different embodiment, the shaping rollers begin the process of imparting a passenger tire tread profile upon the tread.

In another embodiment (not shown), shaping roller 200a contains vacuum inlets (also not shown). The vacuum inlets are disposed at the top surface and allow operation of the shaping roller with a vacuum. Operation with a vacuum involves utilizing a vacuum to remove air from the space between the green tread, the shaping elements, and the top surface. Thus, in one embodiment, vacuum pressure is used in shaping the at least one integral lug on the sheet of green agricultural tire tread. In an alternative embodiment, the vacuum inlets are disposed in the base of the shaping elements (at least in the bottom third of H_{SE}), near top surface 205. As one of ordinary skill in the art will appreciate, this process helps the shaping rollers begin the process of imparting a tread profile upon the tread.

In one known embodiment, the shaping rollers 200a,b are disposed proximate to an extruder (not shown). The green tread 100 may have an elevated temperature subsequent to being extruded, during which time the green tread 100 may be more pliable and more easily shaped by the shaping rollers 200a,b. In one embodiment, a tread profile is imparted upon the tread when the green tread rubber is between 60° C. and 150° C. In an alternative embodiment, a tread profile is imparted upon the tread when the tread rubber is between 80° C. and 120° C. Likewise, as one of ordinary skill in the art will understand, a wide variety of tread rubber formulations will be suitable for use with the methods and constructions described in this disclosure.

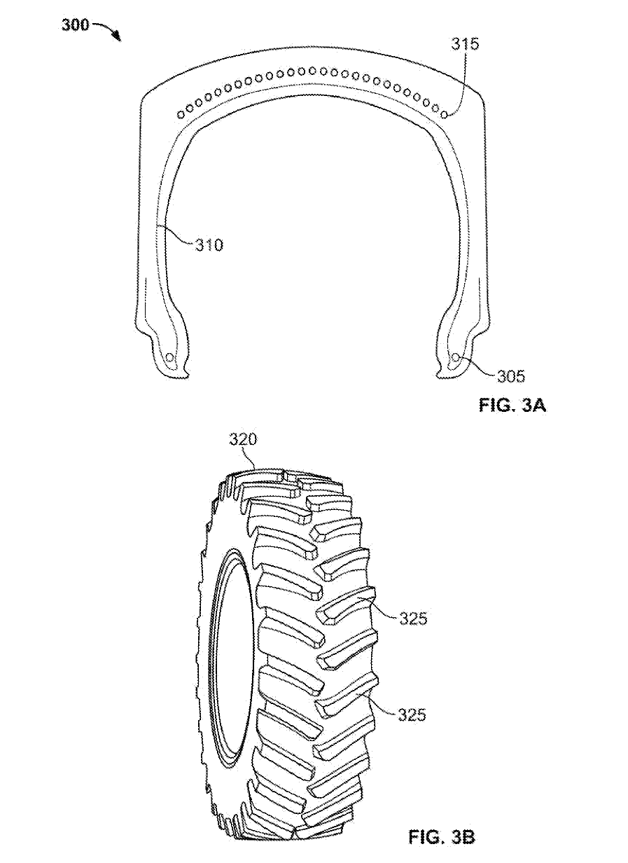

FIG. 3A is a side view of a green tire 300. Green tire 300 includes a pair of annular beads 305 configured to secure the tire to a wheel, at least one body ply 310 extending between the annular beads, and a circumferential belt 315 configured to provide structural reinforcement to the tire. As one of ordinary skill in the art would understand, the tire may also include a reinforcement made from a material selected from the group consisting of steel, nylon, rayon, aramid, para-aramid, polyester, polyethylene naphthalate (“PEN”), polyethylene terephthalate (“PET”), polyvinyl acetate (“PVA”), polybenzobisoxazole (“PBO”), ethylene-carbon monoxide copolymer (“POK”), carbon fiber, and fiberglass.

FIG. 3B is a perspective view of the green tire 300 and pre-shaped tread 320. The pre-shaped tread 320 is an integral rubber article comprising a tread base layer having a base gauge. The pre-shaped tread also has lugs 325. As one of ordinary skill in the art would recognize, the lugs 325 shown in FIG. 3B are lugs for use on a large tire. Examples of large tires include, but are not limited to, agricultural tires, mining tires, forestry tires, skid steer tires, construction tires, monster-truck tires, and other heavy-duty vehicle tires.

In another embodiment, the lugs 325 shown in FIG. 3B are skid lugs for use on an agricultural tire. In this embodiment, the height of the skid lugs is approximately 6% of the tire's width. In additional embodiments, the height of the skid lugs is approximately between 3-8% or 4-7% of the tire's width. In further embodiments, the height of the skid lugs is approximately may be between 6-18% of the tire's width.

In an alternative embodiment (not shown), the lugs 325 shown in FIG. 3B are deep skid lugs for use on an agricultural tire. In this embodiment, the height of the skid lugs is approximately 8% of the tire's width. In additional embodiments, the height of the skid lugs is approximately between 5-20% of the tire's width. In further embodiments, the height of the skid lugs is approximately may be between 6-22% of the tire's width.

In an alternative embodiment (also not shown), the lugs 325 shown in FIG. 3B are skid lugs for use on a relatively narrow tire. In this embodiment, the height of the skid lugs is approximately 14% of the tire's width. In additional embodiments, the height of the skid lugs may be approximately between 10-17% of the tire's width. In further embodiments, the height of the skid lugs is approximately may be between 12-19% or 20-35% of the tire's width.

As one of ordinary skill in the art would recognize, the lugs 325 shown in FIG. 3B may be used in agricultural tire constructions designated as R1, R1W, and R2 constructions, where R1 corresponds to a standard skid depth (Tire & Rim Association Standard AG-09-21), R1W corresponds to a skid depth that is 20% deeper than R1, and R2 corresponds to a skid depth that is 200% of R1. Additional examples of tires utilizing skids include, without limitation, drive wheels for agricultural vehicles, irrigation tires, forestry tires, floatation tires, combine tires, tractor tires, mining tires, construction tires, sprayer tires, and off-the-road vehicles.

In one embodiment, the lugs 325 shown in FIG. 3B are arranged to provide a mono-pitch noise-sequenced tread. In an alternative embodiment, the lugs 325 are modulated to provide a bi-pitch noise-sequenced tread. In yet another embodiment, the lugs 325 are modulated to provide a multi-pitch noise-sequenced tread.

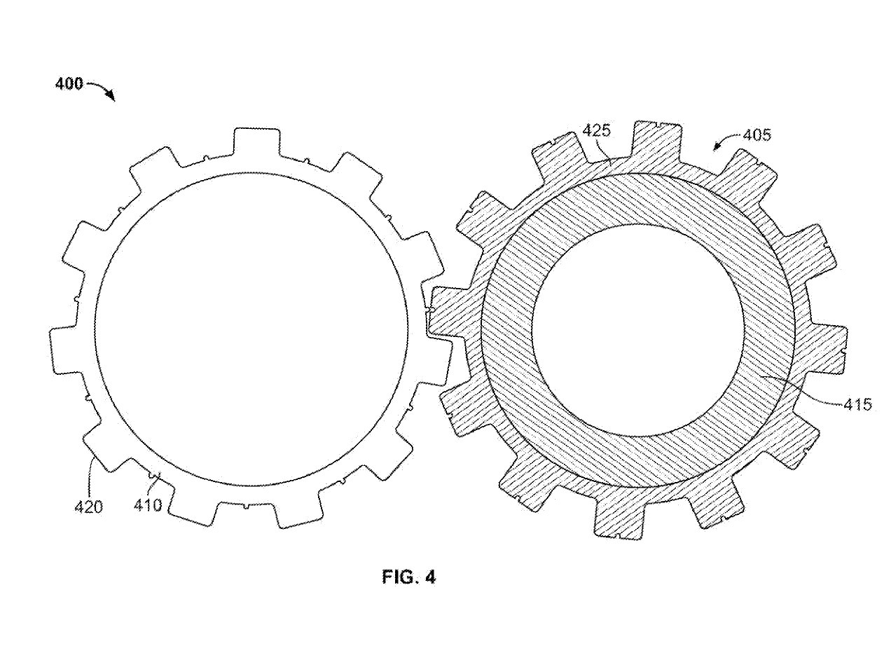

FIG. 4 is a side view of an alternative embodiment employing a stitching roller 400 and an uncured tire 405. As shown, stitching roller 400 is generally cylindrical and has a diameter, D. The diameter extends between opposite edges of the stitching roller's top surface 420. Although diameter D is shown as one size, one of ordinary skill would understand that the length of diameter D may be varied on an application-by-application basis. Additionally, one of ordinary skill in the art would understand that diameter D, as shown in FIG. 4, is not necessarily the equivalent of diameter D shown in FIG. 2, although the two diameters could be equal.

As shown, stitching roller 400 also has a raised profile 410. In one embodiment, the raised profile approximates a void negative in a large tire. In this embodiment, the raised profile approximates a void negative by occupying at least 50% of a finished tire's void volume. In another embodiment, the raised profile approximates the grooves in a tread. In this embodiment, the raised profile approximates the grooves in a tread by occupying at least 50% of a finished tire's groove volume. In yet another embodiment, the raised profile generally resembles a tread negative. In this embodiment, the raised profile approximates various voids, grooves, and sipes in a tread by occupying at least 50% of a finished tire's void, groove, and sipe volume. In a different embodiment, the raised profile closely resembles a tread negative. In this embodiment, the raised profile approximates various voids, grooves, and sipes in a tread by occupying at least 70% of a finished tire's void, groove, and sipe volume.

Uncured tire 405 has a green carcass 415 and a green tread 425. Tread 425 may be pre-formed (similar to 100b-100d), but it may also be flat (similar to 100a). As shown, tread 425 is pre-formed. In one embodiment, no material occupies the space between carcass 415 and tread 425. In another embodiment, material occupies the space between carcass 415 and tread 425. As one of one of ordinary skill would understand, the material between carcass 415 and tread 425 may be a chemical agent such as an adhesive or high-tack rubber layer, such as a cushion.

Stitching roller 400 is supported and held in place by an axial rod (not shown). Likewise, uncured tire 405 is supported and held in place by a tire building drum (also not shown).

The stitching roller 400 and uncured tire 405 are brought into contact. If tread 425 is pre-formed, the raised elements of raised profile 410 should be aligned with the corresponding pre-formed elements of tread 425.

Once stitching roller 400 and uncured tire 405 are in contact, stitching roller 400 is rotated. The rotation will cause uncured tire 405 to rotate in the opposite direction. The rotation and force between stitching roller 400 and uncured tire 405 will reduce the amount of air between carcass 415 and tread 425. Thus, in this embodiment, force is applied to the sheet of tread compound and green carcass after placing the sheet of tread compound is placed upon the green carcass. As one of ordinary skill in the art will appreciate, reducing the amount of air between carcass 415 and tread 425 prior to vulcanization will improve yield.

In another application (not shown), a stitching roller may also help form the lugs on a green tread. The stitching roller may be used to help form lugs on a green tread by placing the stitching roller into contact with the tread. A force is introduced between the stitching roller and the tread so that the stitching roller helps form the lugs on the green tread. The force may be a contact force or a vacuum force, amongst others. If the force is a vacuum force, the stitching roller may include vacuum inlets. The lugs may be formed while the green tread is placed on the green tire or while the green tread is separate from the green tire.

In another application (also not shown), an uncured tire is placed in a vacuum bag. As one of ordinary skill in the art will appreciate, the vacuum bag is an air-tight bag that encloses the uncured tire. A vacuum is then used to remove the air from the vacuum bag, which, in turn, reduces the amount of air between carcass and tread prior to vulcanization. In one embodiment, the vacuum bag may also be configured to help shape the tread. Optionally, chemical agents, such as an adhesive, or a high-tack rubber layer, such as a cushion, may be utilized to secure the tread to the carcass as the vacuum removes air from the vacuum bag.

In another application (also not shown), an uncured tire is placed in a pre-mold. The pre-mold, which may be used in conjunction with a bladder, helps to pre-shape the uncured tire. Pressure may be applied to the pre-mold in order to further shape the uncured tire. As one of ordinary skill in the art will understand, an annular pre-mold may be split into an arc segments, which may be used individually or in conjunction with other arc segments. Likewise, an annular pre-mold may also be split into annular halves, which may be used individually or together. If used together, the annular pre-mold halves will pre-form an entire tread (360°) at one time. The pre-mold may be made of a variety of materials, including, without limitation, ceramic, plastic, and metal.

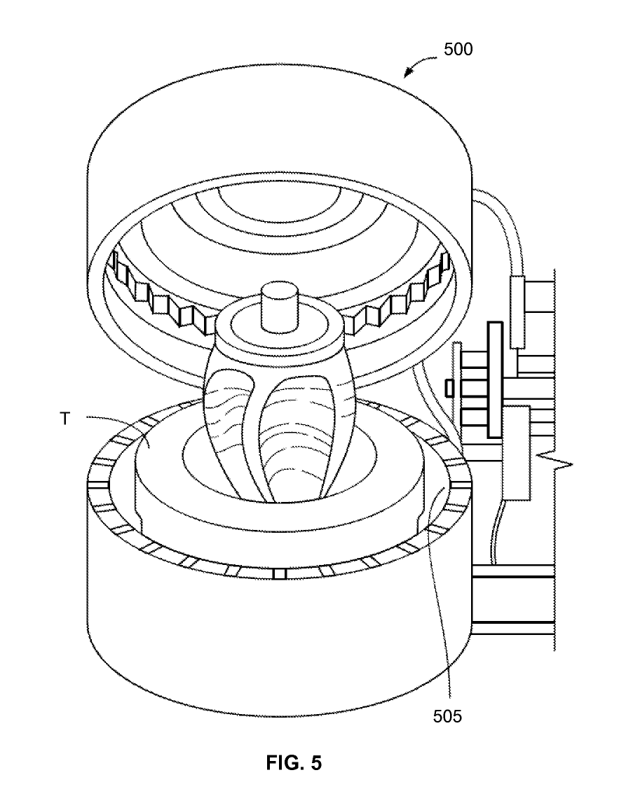

FIG. 5 shows a tire mold 500 with mold features 505, having a tire T disposed therein. As one of ordinary skill in the art will appreciate, the mold features are an exact tread negative. In an alternative embodiment, the mold features generally correspond to a tread negative. In another alternative embodiment, the mold features generally correspond to the larger voids in a tread. In another specific embodiment, the mold is a compression mold that has a top lid that pushes rubber into mold voids as upper and lower plates of a mold flat press are closed. As one of ordinary skill in the art would understand, the tread or the tire may also be modified post-cure.

As one of ordinary skill in the art will appreciate, the methods and constructions described in this disclosure will improve yield. For instance, reducing the volume between the green tire and the mold features may help improve yield because it reduces variation (such as belt wave) in various reinforcing structures. The methods and constructions described in this disclosure may reduce belt wave, particularly in large tires and agricultural tires, where portions of the belt have been known to migrate into a lug during vulcanization.

Likewise, the methods and constructions described in this disclosure may improve cord distortion and improve tire appearance. The methods and constructions described in this disclosure may also allow for rubber savings. For example, the methods and constructions described herein may require between approximately 10-15% less material.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A method of manufacturing an agricultural tire comprising:
providing a sheet of green agricultural tire tread compound;
shaping at least one integral lug on the sheet of green agricultural tire tread compound with at least one roller;
placing the sheet of green agricultural tire tread compound on a green carcass;
placing the green agricultural tire tread compound and green carcass into an agricultural tire mold;
curing the green agricultural tire tread and green carcass; and
removing the cured agricultural tire from the mold.

2. The method of claim 1, wherein providing the sheet of agricultural tire tread compound includes extruding rubber to provide a sheet of green agricultural tire tread compound.

3. The method of claim 1, wherein vacuum pressure is used in shaping the at least one integral lug on the sheet of green agricultural tire tread.

4. The method of claim 1, wherein the at least one roller is a cylindrical die bearing a tread pattern.

5. The method of claim 1, further comprising applying force to the sheet of agricultural tire tread compound and green carcass after placing the sheet of green agricultural tire tread compound on a green carcass.

6. The method of claim 1, wherein placing the sheet of agricultural tire tread compound and green carcass into an agricultural tire mold includes aligning the sheet of agricultural tire tread compound with at least one corresponding mold feature.

7. The method of claim 1, wherein curing the agricultural tire tread and green carcass requires no more than 240 minutes of curing.

8. The method of claim 1, wherein the placing step precedes the shaping step.

9. A tire manufacturing method comprising the steps of:
providing an uncured tire, the uncured tire comprising at least a carcass and a tread;
introducing the uncured tire to a tread negative;
applying pressure to the tread negative to at least partially impart a circumferential profile upon the uncured tire; and
vulcanizing the uncured tire in order to obtain a vulcanized tire.

10. The method of claim 9, wherein the applying pressure to the tread negative step is performed with a curved stamping plate.

11. The method of claim 9, wherein the applying pressure to the tread negative step precedes the providing an uncured tire step.

12. The method of claim 9, wherein preparing the uncured tire for vulcanization includes placing the tire in a mold and introducing viscous rubber to at least partially fill a void the mold.

13. The method of claim 9, wherein applying pressure to the tread negative to at least partially impart a circumferential profile upon the uncured tire includes applying vacuum pressure at the deepest portion of the tread negative.

14. The method of claim 9, wherein preparing the uncured tire for vulcanization includes placing the tire in a mold and introducing viscous rubber to at least partially fill a void the mold.

15. The method of claim 9, wherein the uncured tire contains at least one reinforcement made from a material selected from the group consisting of steel, nylon, rayon, aramid, para-aramid, polyester, PEN, PET, PVA, PBO, POK, carbon fiber, and fiberglass.

16. The method of claim 9, wherein the tread negative is circular and has a diameter, D₁, the uncured tire has a diameter, D₂, and the ratio of D₁ to D₂ is less than 1.

17. The method of claim 9, wherein the tread negative is circular and has a diameter, D₁, the uncured tire has a diameter, D₂, and the ratio of D₁ to D₂ is greater than or equal to 1.

18. A green agricultural tire comprising:
a carcass and a pre-shaped tread, wherein:
the carcass includes a pair of annular beads configured to secure the tire to a wheel, at least one body ply extending between the annular beads; a circumferential belt, the circumferential belt configured to provide structural reinforcement to the tire; and
the pre-shaped tread is an integral rubber article comprising a tread base layer having a base gauge and skid lugs, wherein the skid lugs are deep skid lugs configured for use on an agricultural tire.

19. The tire of claim 18, wherein the height of the deep skid lugs is at least 20% of the tire width.

20. The tire of claim 18, wherein the height of the deep skid lugs is at least 40% of the tire width.
